(19) United States
(12) Patent Application Publication
(10) Pub. No.: US 2011/0181572 A1
(43) Pub. Date: Jul. 28, 2011

(54) ELECTRONIC DEVICES OPERABLE TO USE ADJUSTED DATA SIGNALS AND PROCESSES OF MAKING AND USING THE SAME

(75) Inventors: Zhining Chen, Goleta, CA (US); Gang Yu, Santa Barbara, CA (US)

(73) Assignee: E.I. DUPONT DE NEMOURS AND COMPANY

(21) Appl. No.: 12/342,537

(22) Filed: Dec. 23, 2008

Related U.S. Application Data
(60) Provisional application No. 61/017,236, filed on Dec. 28, 2007.

(51) Int. Cl. G09G 5/00

(52) U.S. Cl. 345/211; 345/204

(57) ABSTRACT

A first electronic device can include a radiation-emitting component; and a processor operable to receive an input data signal for the radiation-emitting component, receive performance information generated from a second electronic device, wherein the first electronic device and the second electronic device were fabricated in a same batch, and generate an adjusted data signal using the input data signal and the performance information. Processes of making and using the electronic devices are also disclosed.

### CROSS REFERENCE TO RELATED APPLICATIONS

This application claims the benefit of priority under 35 U.S.C. §119(e) from provisional U.S. Application No. 61/017,236, filed Dec. 28, 2007, which is incorporated herein by reference in its entirety.

### FIELD OF THE INVENTION

This invention relates in general to electronic devices and processes, and more particularly, to electronic devices operable to use adjusted data signals and processes of making and using the same.

### DESCRIPTION OF THE RELATED ART

An electronic device can include a liquid crystal display (“LCD”), an organic light-emitting diode (OLED) display, or the like. Active matrix OLED displays can include an OLED and a power transistor connected in series between two power lines, such as Vdd and Vss. Active matrix OLED displays typically have two problems that can get worse over time. Luminance can decrease because the organic semiconductor material within the OLED degrades. One prior art attempt to address the decreased luminance is to include a sensor within each pixel of the display to monitor luminance. In response to information from the sensor, the current through OLEDs within a pixel can be increased so that the luminance, as seen by a user, remains substantially constant. The additional sensor within each pixel occupies valuable area within a display. Thus, the additional sensor reduces the effective aperture ratio (light emitting area within the display to the total area of the display) and requires driving the OLEDs under higher current conditions to achieve the same luminance as compared to an OLED display without sensors within each pixel.

The power transistor is usually a metal-insulator-semiconductor field-effect transistor (“MISFET”). Charge carriers can accumulate within the gate dielectric of the MISFET because the power transistor is on nearly all the time when the display is operating. The amount of accumulated charge within the gate dielectric is proportional to the voltage difference between the gate and the source (“Vgs”) and the time at Vgs. A variety of compensation schemes have been proposed, of which many include modifying the control circuits for the pixels. One example includes adding another transistor that is connected to the storage node of the control circuit. Similar to the sensor previously described, the additional transistors occupy valuable display area and reduces aperture ratio. Another compensation scheme replaces a single-gated power MISFET with a double-gated power MISFET. The double-gated power MISFET is more complicated to fabricate and can result in reduced yield due to additional processing and handling.

Regardless whether control circuits are not changed, compensation schemes to remove trapped charge carriers within the power MISFET are typically employed when the display is in a standby or power down mode. The compensation scheme does not affect the display in real time, as compensation is only performed when the display is not in use.

### SUMMARY

A first electronic device can include a radiation-emitting component; and a processor operable to receive an input data signal for the radiation-emitting component, receive performance information generated from a second electronic device, wherein the first electronic device and the second electronic device were fabricated in a same batch, and generate an adjusted data signal using the input data signal and the performance information.

In another aspect, a process of making and using electronic devices can include fabricating a first batch of electronic devices, wherein the first batch includes a first electronic device and a second electronic device. The process can also include generating first performance information using the second electronic device, and providing the first performance information to the first electronic device. The process can further include fabricating a second batch of electronic devices, wherein the second batch includes a third electronic device and a fourth electronic device, and generating second performance information using the fourth electronic device, wherein the second performance information is different from the first performance information. The process can still further include providing the second performance information to the third electronic device. The first, second, third, and fourth electronic devices can be the same model and include a radiation-emitting component.

In another aspect, a process of using a first electronic device can include, at a processor, receiving an input data signal for a radiation-emitting component of the first electronic device. The process can also include generating an adjusted data signal using the input data signal and performance information, wherein the performance information was generated from a second electronic device that was fabricated in a same batch as the first electronic device.

The foregoing general description and the following detailed description are exemplary and explanatory only and are not restrictive of the invention, as defined in the appended claims.

### BRIEF DESCRIPTION OF THE DRAWINGS

The invention is illustrated by way of example and not limitation in the accompanying figures.

FIG. 1 includes a block diagram of an electronic device.

FIG. 2 includes a block diagram of a graphics sub-system within the electronic device.

FIG. 3 includes a schematic diagram of a pixel within a display of the electronic device.

FIG. 4 includes a flow diagram of a process of making and using the electronic device from a perspective of a fabricator of the electronic device fabricator.

FIGS. 5 and 6 include a flow diagram of a process of using the electronic device from a perspective of a user of the electronic device.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

A first electronic device can include a first radiation-emitting component and a first processor operable to receive a first input data signal for the first radiation-emitting component, receive performance information generated from a second electronic device, wherein the first electronic device and the second electronic device were fabricated in a same batch; and generate a first adjusted data signal using the first input data signal and the performance information.

In an embodiment of the first aspect, generate the first adjusted data signal includes generate the first adjusted data signal using first historic data, the first input data signal, and the performance information. In a particular embodiment, the first historic data includes (i) time information and (ii) voltages of other first input data signals, voltages of the other first adjusted data signals, currents flowing through the first radiation-emitting component, or any combination thereof. In another embodiment, the first electronic device further includes an electrode control module operable to change a voltage of a first cathode of the first electronic device, a first anode of the first electronic device, or a combination thereof.

In still another embodiment of the first aspect, the first radiation-emitting component includes a first organic semiconductor material having a first emission maximum at a first wavelength. The first electronic device can further include a second radiation-emitting component including a second organic semiconductor material having a second emission maximum at a second wavelength different from the first wavelength, and a third radiation-emitting component including a third organic semiconductor material having a third emission maximum at a third wavelength, wherein the third wavelength is different from each of the first and second wavelengths. In a particular embodiment, the first processor is further operable to receive a second input data signal for the second radiation-emitting component, generate a second adjusted data signal using the second input data signal and the performance information, receive a third input data signal for the third radiation-emitting component, and generate a third adjusted data signal using the third input data signal and the performance information. In a more particular embodiment, the first electronic device further includes a second processor operable to receive the first adjusted data signal, the second adjusted data signal, and the third adjusted data signal, and generate a first processed signal, a second processed signal, and third processed signal from the first adjusted data signal, the second adjusted data signal, and the third adjusted data signal, respectively.

In a second aspect, a process of making and using electronic devices can include fabricating a first batch of electronic devices, wherein the first batch includes a first electronic device and a second electronic device, and generating first performance information using the second electronic device. The process can also include providing the first performance information to the first electronic device. The process can further include fabricating a second batch of electronic devices, wherein the second batch includes a third electronic device and a fourth electronic device, and generating second performance information using the fourth electronic device, wherein the second performance information is different from the first performance information. The process can still further include providing the second performance information to the third electronic device. The first, second, third, and fourth electronic devices can be the same model and include a first radiation-emitting component.

In an embodiment of the second aspect, providing the first performance information includes storing the first performance information in a memory of the first electronic device. In a particular embodiment, providing the first performance information includes transmitting the first performance information over an Internet to the first electronic device. In another embodiment, the process further includes updating the first performance information to generate updated performance information and transmitting the updated performance information over the Internet to the first electronic device.

In a further embodiment of the second aspect, the process further includes fabricating additional batches of electronic devices, wherein each of the additional batches includes a user electronic device and a tested electronic device. For each additional batch, the process can also include generating additional performance information from the tested electronic device and providing the additional performance information to the user electronic device within the same additional batch as a corresponding tested electronic device. In still a further embodiment, the first radiation-emitting component includes a first organic semiconductor material having a first emission maximum at a first wavelength. Each of the first, second, third, and fourth electronic devices can further include a second radiation-emitting component includes a second organic semiconductor material having a second emission maximum at approximately a second wavelength that is significantly different from the first wavelength, and a third radiation-emitting component includes a third organic semiconductor material having a third emission maximum at approximately a third wavelength that is significantly different from each of the first and second wavelengths.

In a third aspect, a process of using first electronic device can include, at a first processor, receiving a first input data signal for a first radiation-emitting component of the first electronic device. The process can also include generating a first adjusted data signal using the first input data signal and performance information, wherein the performance information was generated from a second electronic device that was fabricated in a same batch as the first electronic device.

In an embodiment of the third aspect, generating the first adjusted data signal includes generating the first adjusted data signal using first historic data, the first input data signal, and the performance information. In a particular aspect, the first historic data includes (i) time information and (ii) voltages of other first input data signals, voltages of the other first adjusted data signals, currents flowing through the first radiation-emitting component, or any combination thereof. In another embodiment, the process further includes changing a voltage of a first cathode of the first electronic device, a first anode of the first electronic device, or a combination thereof. In still another embodiment, the process further includes receiving the performance information over the Internet and storing the performance information in a memory of the first electronic device.

In a further embodiment of the first aspect, the first radiation-emitting component includes a first organic semiconductor material having a first emission maximum at a first wavelength. The first electronic device further can further include a second radiation-emitting component includes a second organic semiconductor material having a second emission maximum at a second wavelength different from the first wavelength, and a third radiation-emitting component includes a third organic semiconductor material having a third emission maximum at a third wavelength, wherein the third wavelength is different from each of the first and second wavelengths. In a particular embodiment, the process further includes, at the first processor, receiving a second input data signal for the second radiation-emitting component and receiving a third input data signal for the third radiation-emitting component. The process can also include generating a second adjusted data signal using the second input data signal and the performance information and generating a third adjusted data signal using the third input data signal and the performance information.

Many aspects and embodiments are described herein and are merely exemplary and not limiting. After reading this specification, skilled artisans appreciate that other aspects and embodiments are possible without departing from the scope of the invention.

Other features and benefits of any one or more of the embodiments will be apparent from the following detailed description, and from the claims. The detailed description first addresses Definitions and Clarification of Terms followed by System Description of an Exemplary Electronic Device, Process of Making and Using Electronic Devices, and finally Benefits.

### 1. Definitions and Clarification of Terms

Before addressing details of embodiments described below, some terms are defined or clarified.

The term “batch” is intended to mean a set of substrates, electronic devices, etc. that are fabricated as a unit. The individual substrates or individual electronic devices may be processed at substantially the same time or may be processed serially. The individual substrates or individual electronic devices are typically moved as a unit between processing tools. A batch can also be referred to as a lot.

The term “model” is intended to mean a set of electronic devices having substantially identical sets of electrical components and electrical connections between those electrical components. Each model is typically assigned a model number, and therefore the electronic devices of the same model have the same model number.

The term “organic semiconductor material” is intended to an organic material, by itself, or when in contact with a dissimilar material is capable of forming a rectifying junction. The term “organic semiconductor region” is intended to mean a region including an organic semiconductor material.

The term “rectifying junction” is intended to mean a junction within a semiconductor layer or within a semiconductor region or a junction formed by an interface between a semiconductor layer or a semiconductor region and a dissimilar material, in which charge carriers of one type flow easier in one direction through the junction compared to the opposite direction. A pn junction is an example of a rectifying junction that can be used as a diode.

The term “signal line” is intended to mean a line over which a signal can be transmitted. The signal transmitted may be substantially constant or vary over time. Signal lines can include control lines, data lines, scan lines, select lines, power supply lines, or any combination thereof. Note that a signal line may serve one or more principal functions.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Group numbers corresponding to columns within the Periodic Table of the elements use the “New Notation” convention as seen in the CRC Handbook of Chemistry and Physics, 81^{st} Edition (2000-2001).

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

To the extent not described herein, many details regarding specific materials, processing acts, and circuits are conventional and may be found in textbooks and other sources within the organic light-emitting diode display, photodetector, photovoltaic, and microelectronic arts.

### 2. System Description of an Exemplary Electronic Device

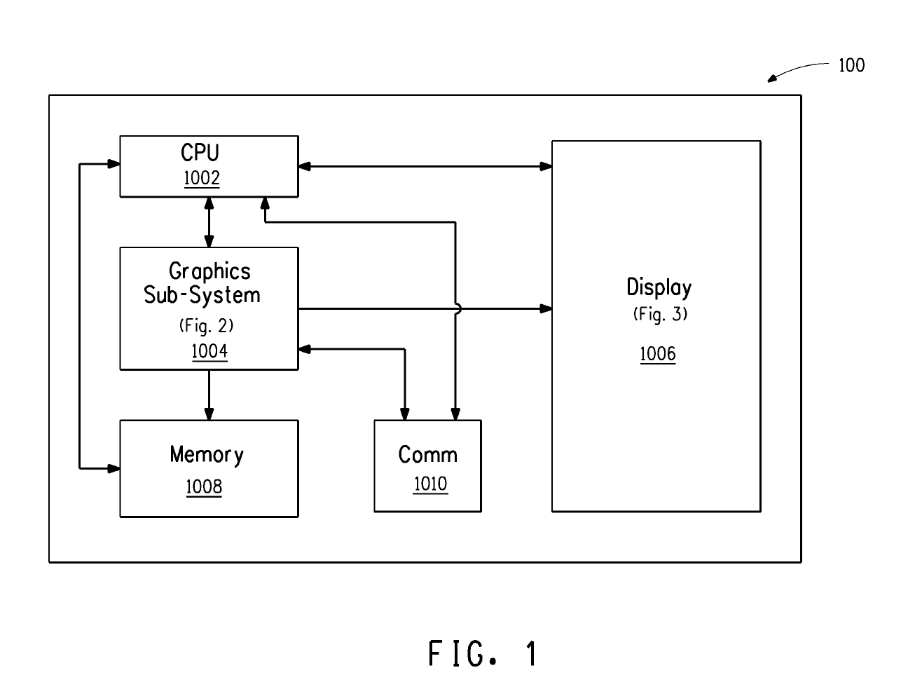

FIG. 1 includes a block diagram of an electronic device 100. The electronic device 100 includes a central processing unit (“CPU”) 1002 that is bi-directionally coupled to a graphics sub-system 1004, a display 1006, a memory 1008, and a communications module (“COMM”) 1010. The CPU 1002 can be part of a microprocessor, a microcontroller, or included within a chip set.

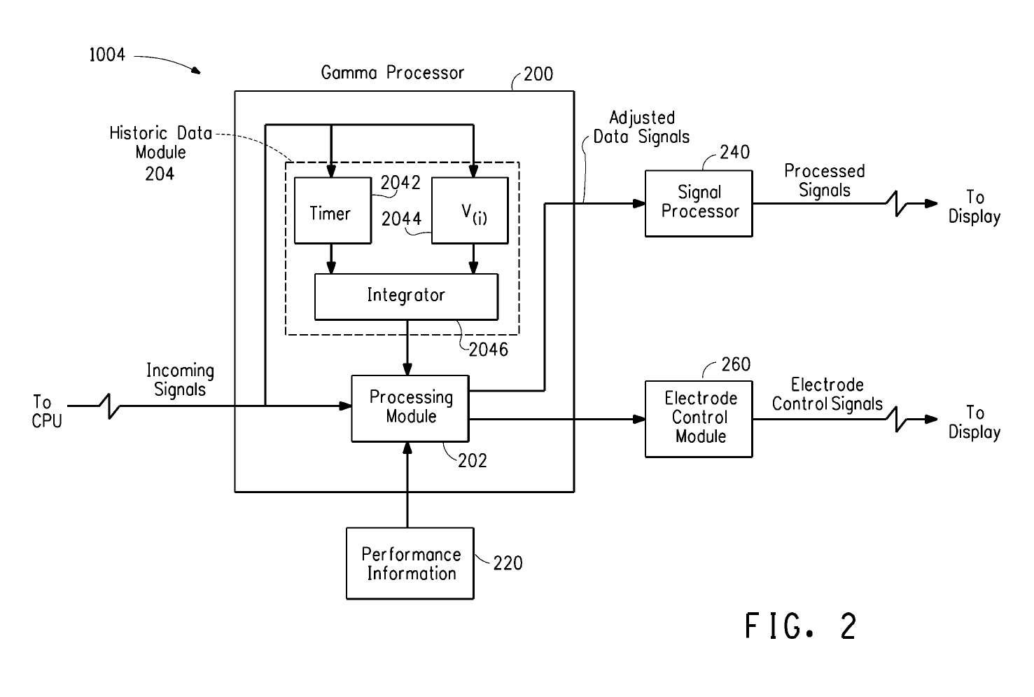

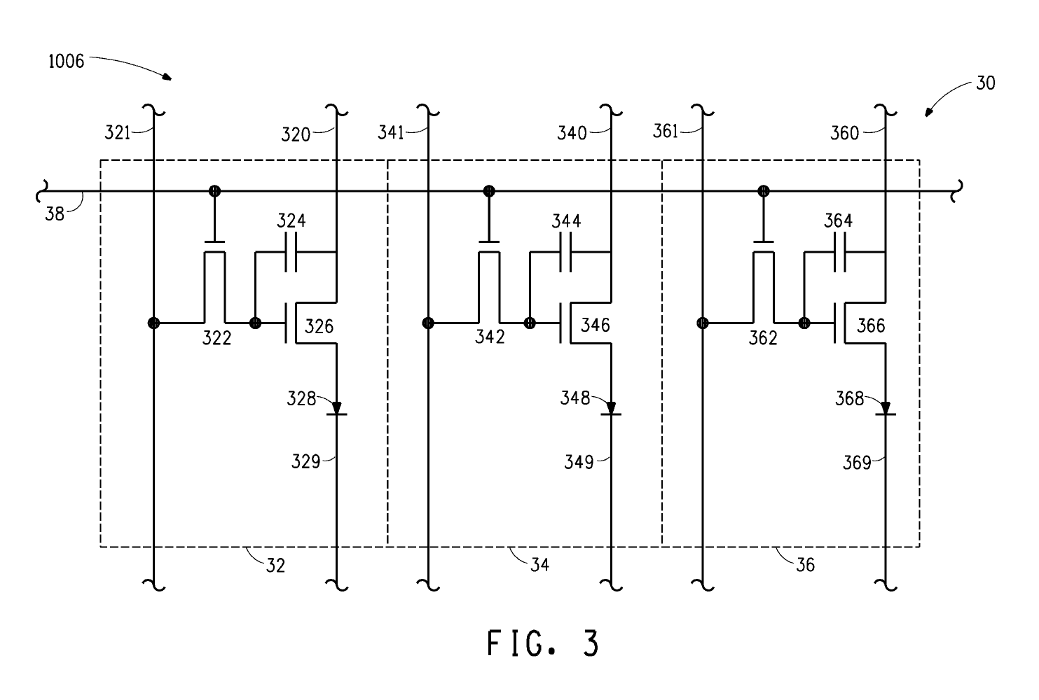

The graphics sub-system 1004 is bi-directionally coupled to the display 1006, the memory 1008, and COMM 1010. The graphics sub-system 1004 is operable to receive data and other information from the CPU 1002, memory 1008, COMM 1010, or any combination thereof, and provide display signals to the display 1006. In one embodiment, the display 1006 can be full-color, active matrix display organized into rows and columns of pixels. The details regarding particular embodiments of the graphics sub-system 1004 and the display 1006 are described in more details with respect to FIGS. 2 and 3, respectively.

The memory 1008 can be a single memory or a collection of memories. The memory 1008 can include read-only memory, random-access memory, flash memory, a disk drive, a storage network, another suitable memory, or the like. COMM 1010 can include a network interface card or other suitable communications module. The electronic device can be coupled to a local area network, a wide area network, the Internet, or any combination thereof.

FIG. 2 includes a block diagram of the graphics sub-system 1004 in accordance with one embodiment. The graphics sub-system 1004 can receive incoming data signals from the CPU 1002. In alternative embodiments, the incoming data signals may be received from the memory 1008, COMM 1010, or both in addition to or in conjunction with the CPU 1002. The incoming data signals are received by a gamma processor 200. The gamma processor 200 is operable to process the incoming data signals to generate adjusted data signals, wherein the adjusted data signals adjust the incoming data signals to account for trapped charge carriers within the gate dielectric of the power transistors, degradation of organic semiconductor materials, or any combination thereof within the pixels of the display 1006.

In one embodiment of the gamma processor 200, the incoming data signals are received by a processing module 202 and a historic data module 204. The historic data module 204 includes information regarding time and an electrical parameter of the display 1006. In another embodiment, the historic data module 204 can also include the operating temperature of display 1006 or another part of the electronic device 100. In one embodiment, the historic data module 204 includes a timer 2042 and a voltage monitoring unit 2044 and may include a temperature monitoring unit (not illustrated). The timer 2042 can generate time information with respect to when the gamma processor 200 receives incoming data signals, and the voltage monitoring unit 2044 receives incoming data signals. The historic data module 204 can include an integrator 2046 that is operable to integrate the voltages from the incoming data signals over time on a pixel-by-pixel or a subpixel-by-subpixel basis. The integrated data from the integrator 2046 is sent to and received by the processing module 202. In other embodiments (not illustrated), the electrical parameter can include voltages from the adjusted data signals or currents flowing through the radiation-emitting components within the display 1006 instead of the voltages of the incoming data signals. When voltages are used, such voltages may be Vgs or other information representative of Vgs. In yet another embodiment, the integrated data from the integrator 2046 can integrate the operating temperatures of the display 1006 or other portion of the electronic device 100 over time.

The processing module 202 is operable to receive the incoming data signals, historic data, and performance information 220 to generate the adjusted data signals. The performance information 220 characterizes how the display 1006 will operate based on characterization data. In one embodiment, the performance information 220 is collected on a different electronic device that is the same model as the electronic device 100. In a particular embodiment, the different electronic device and the electronic device 100 are fabricated in the same batch. In this manner, the different electronic device would have substantially identical electrical, physical, and aging characteristics as the electronic device 100.

The performance information 100 can include information regarding how the incoming data signals would need to be adjusted to achieve the desired luminance of the display. For example, the incoming data signals may reflect a desired output and luminance of the display 100. However over time, charge carriers can become trapped within the gate dielectrics of the power transistors, and the organic semiconductor materials degrade. If the incoming data signals are not adjusted, the color balance or luminance may not correspond to the desired output. The performance information 220 can be used to adjust for time-related phenomena to generate adjusted data signals that can produce the desired output and luminance of the display 100. The performance information 220 can be in the form of a data table or an equation. When in the form of a data table, the data table can include luminance, voltage or current, and time information collected from the different electronic device, as previously described. Thus, for a desired luminance and time, the performance information 220 can be used to determine actual signals that should be used to achieve the desired luminance at the then-current operating state.

The performance information 220 can be stored in the memory 1008, a register within the CPU 1002, graphics sub-system 1004, or at multiple locations within the electronic device 100. Alternatively, the performance data can be provided to the electronic device 100 over the Internet via COMM 1010. In a particular embodiment, updated performance information may become available after the end user has the electronic device 100. The updated performance information can provide to the electronic device 100 over the Internet via COMM 1010.

The processing module 202 is operable to send the adjusted data signals from the gamma processor 200 and to by the signal processor 240. The signal processor 240 is operable to receive the adjusted data signals and generate processed signals from the adjusted data signals that are transmitted to the display 1006. The signal processor 240 can include a digital-to-analog converter, a filter, another suitable circuit, or any combination thereof. In one embodiment, the processed signals may be received by a display driver (not illustrated), which is operable to drive the processed signals to the display 1006.

The processing module 220 can also be operable to control the voltages of the power supply lines. The processing module 220 may use the historic data and the performance information 220 to generate signals to an electrode control module 260. The processing module 220 may use the same or different information when generating signals for the electrode control module 260 as compared to generating the adjusted data signals. For example, the adjusted data signals may take into account whether the power transistors have been compensated, whereas the signals for the electrode control module 260 may not. In a particular embodiment, the voltages on the power supply lines may be primarily a function of the luminance of the pixels and the time at that luminance. For example, when Vgs is negative during compensation (to remove trapped charge carriers from the gate dielectrics in the power transistors), the radiation-emitting components are not emitting radiation. Thus, when Vgs is negative, the time at a negative Vgs may be ignored for electrode control purposes. In another embodiment, negative Vgs may be considered, as an OLED can act as a sensor when properly reverse biased, and a relatively smaller but significant current may flow through the organic semiconductor material of the OLED.

The electrode control module 260 is operable to receive the signals from the processing module 202 of the gamma processor 200 and maintain the power supply lines for the display 1006 at the proper voltages. An additional circuit, such as a transformer, a charge pump, or other suitable circuit can be used within or in addition to the electrode control module 260.

The modules can include logic that is in hardware, firmware, software, or any combination thereof. After reading this specification, skilled artisans will appreciate that the functions of one module may be combined with functions of another module or may be split between different modules, and thus, more or fewer modules may be used than are illustrated in FIGS. 1 and 2. For example, the integrator 2046 of the historic data module 204 can be part of the processor 202. The electrode control module 260 can be combined with the processing module 202. Alternatively, part or all of the historic data module 204 can be included within the CPU 1002, and the electrode control module 260 can be included within a power management module (not illustrated) for the electronic device 100. Other configurations are possible, and therefore, the present invention is not limited to the embodiments illustrated.

The display 1006 can include pixels arranged in rows and columns. FIG. 3 includes a schematic diagram of a pixel 30 within the display 1006. Referring to FIG. 3, each subpixel includes a select transistor (322, 342, 362), a capacitor (324, 344, 364), a power transistor (326, 346, 366), and a radiation-emitting element (328, 348, and 368). The source of the select transistor (322, 342, 362) is connected to its corresponding data line (321, 341, 361). The drain of the select transistor (322, 342, 362) is connected to an electrode of the capacitor (324, 344, 364) and a gate of the power transistor (326, 346, 366). The other electrode of the capacitor (324, 344, 364) is connected to the drain of the power transistor (326, 346, 366) and the subpixel's corresponding Vdd line (320, 340, 360). The source of the power transistor (326, 346, 366) is connected to the anode of the radiation-emitting element (328, 348, 368). The cathode of the radiation-emitting element (328, 348, 368) is connected to the Vss line (329, 349, and 369). The Vdd lines 320, 340, and 360 may be controlled independent of one another or may be connected to a common Vdd line, and the Vss lines 329, 349, and 369 may be controlled independent of one another or may be connected to a common Vss line. The Vdd lines 320, 340, 360, the Vss lines 329, 349, 369, or any combination thereof may be controlled by the electrode control module 260 in FIG. 2.

In this particular embodiment, the radiation-emitting elements (328, 348, 368) are radiation-emitting diodes having an organic semiconductor material. The composition of the organic semiconductor material may be different between a red subpixel 32, a green subpixel 34, and a blue subpixel 36. Otherwise, the composition and structure of the other electrical components within the subpixels are substantially the same. The fabrication of the pixel 30 can be performed using conventional or proprietary processes and materials.

Other pixel circuits can be used. For example, the power transistors 326, 346, 366, or any combination thereof can be replaced by p-channel transistors, rather than the n-channel transistors as illustrated in FIG. 3. The radiation-emitting components 328, 348, 368, or any combination thereof may be reversed with respect to the power transistors. In a particular embodiment, the anodes of the radiation-emitting components 328, 348, and 368 can be connected to the Vdd lines 320, 340, and 360, respectively; the cathodes of the radiation-emitting components 328, 348, and 368 can be connected to the drains of the power transistors 326, 346, and 366, respectively; and the sources of the power transistors 326, 346, and 366 can be connected to the Vss lines 329, 349, and 369, respectively. The electrodes of the capacitors 324, 344, and 364 can be connected to the Vss lines 329, 349, and 369, respectively, rather than the Vdd lines. In still other embodiments, more components, circuit configurations (arrangements of components), or any combination thereof can be used.

When the pixel 30 is normally operating, charge carriers can become trapped within the gate dielectrics of the power transistors 326, 346, and 366. Also, the organic semiconductor material within the radiation-emitting components 328, 348, and 368 degrade as the display 1006 is used. The graphics sub-system 1004, as described with respect to FIG. 2 can be used to adjust for the trapped charge carriers, organic semiconductor material degradation, or any combination thereof.

### 3. Process of Making and Using Electronic Devices

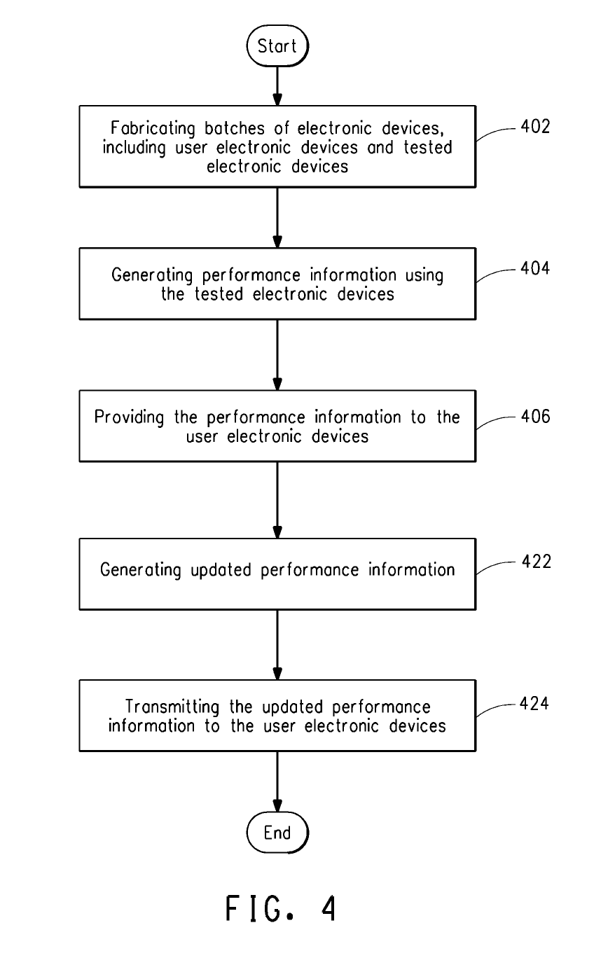

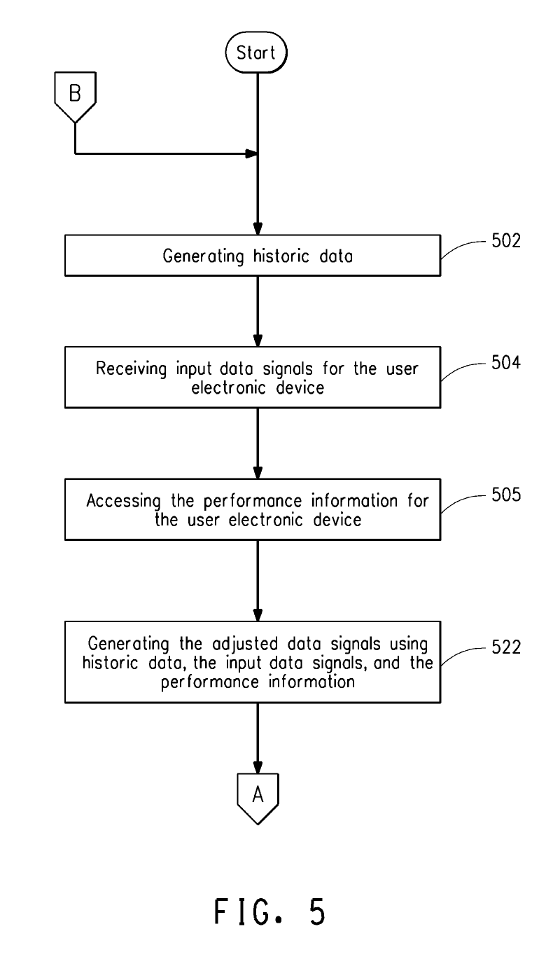

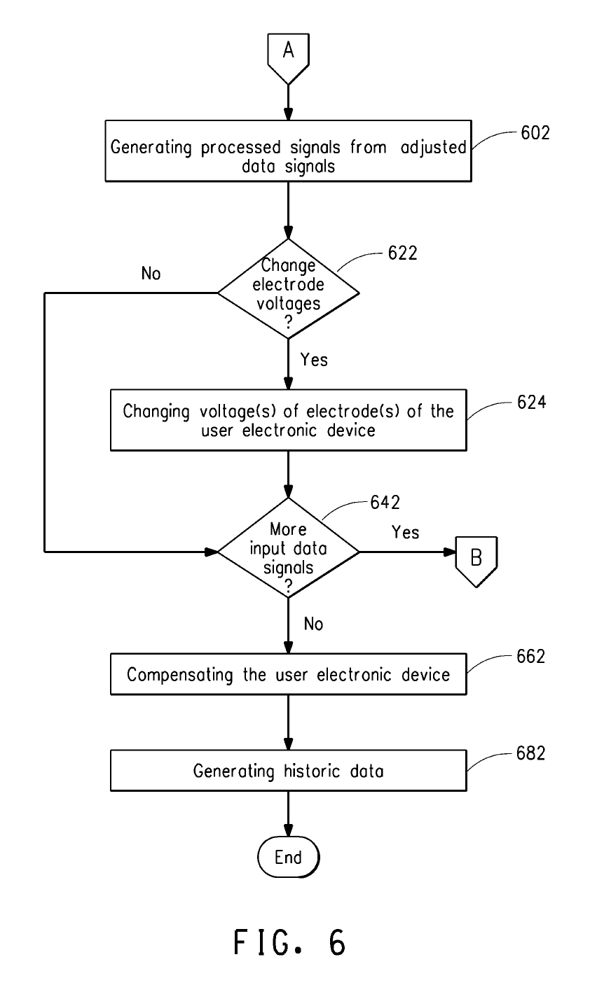

Processes are described in FIGS. 4 to 6 regarding processes of making and using the electronic devices. FIG. 4 focuses more on a process that can be implemented by the electronic device fabricator, and FIGS. 5 and 6 focus more on a process that can be used by an end user of the electronic device 100.

FIG. 4 includes a flow chart directed to a process of making and using electronic devices from the perspective of an electronic device fabricator. The process includes fabricating batches of electronic devices, including user electronic devices and tested electronic devices, at block 402. While the electronic devices are being fabricated, particular electronic devices may not be identified at the time of fabrication as user electronic devices, which will eventually sold or otherwise provided to end users, and tested electronic devices, which may be used to test, characterize, generate performance data, etc. After fabrication has been completed, all electronic devices from the batches may be tested for basic functionality. Such basic functionality can be to check for electrical opens, electrical shorts, dead pixels, etc. Within each batch, an electronic device can be designated as a tested electronic device to perform additional actions, if the tested electronic device has not previously been designated.

The process can also includes generating performance information using the tested electronic devices, at block 404. The performance information can include measurements of luminance, voltage, current, time, another parameter, or any combination thereof while the tested electronic device is being operated. The tested electronic device may or may not be compensated to remove trapped charge carriers from the gate dielectrics of the power transistors within the display. The empirical data collected from the tested electronic device is expected to be substantially identical as the user electronic devices from the same batch.

The empirical data can reflect how the electronic devices from the same batch will perform over time, particularly in view of trapped charge carriers within the gate dielectrics of the power transistors and degradation of the organic semiconductor materials within the radiation-emitting components. The empirical data can be used as the performance information, or the performance information can be derived from the empirical data. In one embodiment, the performance information can be separated by the type of radiation-emitting component. For example, if the display includes red light emitting components, green light emitting components, and blue light emitting components, the performance information can include three sets of information: red, green, and blue. In another embodiment, the performance information can be separated on a subpixel-by-subpixel basis or another basis (subpixels near the edge of the display vs. subpixels near the center of the display). After reading this specification, skilled artisans can separate or otherwise classify the empirical data to generate performance information that meets their particular needs or desires. The performance information can be in the form of a data table or an equation. The performance information can be used by the graphics sub-systems of the electronic devices to generate electrical parameters (adjusting input data signals, voltages to be used for the power supply lines, etc.) to produce a desired output and luminance at the display of the electronic device.

The process can also include providing the performance information to the user electronic devices, at block 406. In one embodiment, the performance information can be installed, loaded, or otherwise placed into the user electronic devices before the user electronic devices are provided to the end users. This action could occur at the fabricator, a testing facility, a downstream fabricator (e.g., the original fabricator can be a display fabricator, and the downstream fabricator could be a computer company that sells computers with the displays), or another third party. Alternatively, the performance information can be provided over the Internet to the end users of the user electronic devices. More particularly, the first time that the user electronic device is used and coupled to a network, the user electronic device can send a request for the performance information. The performance information can be sent to and automatically installed, loaded, or otherwise placed into an appropriate location within the user electronic device. Regardless of the particular manner in which the performance information is provided, the performance information can be stored in memory, and more particularly, in persistent memory. Examples of locations include read-only memory, flash memory, registers, a disk drive, or the like.

Optionally, updated performance information can become available as more empirical data is collected from tested electronic devices. The process can further include generating the updated performance information, at block 422, and transmitting the updated performance information to the user electronic devices, at block 424. In one particular embodiment, the updated performance information can be transmitted over the Internet to the user electronic devices. The updated performance information may be provided in response to a request or may be pushed to the user electronic devices.

FIGS. 5 and 6 are directed to processes using the user electronic device during normal operation. To simplify understanding, the process is described in an embodiment in which performance data currently accessible within the electronic device or accessible to the electronic device (e.g., in a disk drive or a flash memory stick attached to the electronic device).

The process includes generating historic data, at block 502 in FIG. 5. The historic data can be generated as the user electronic device operates. The historic data can include time information, voltages, currents, operating temperatures, or any combination thereof. In a particular embodiment, the historic data can include input data signal or operating temperatures integrated over time. In another embodiment, the historic data can include Vgs measurements integrated over time. The historic data can be received by the processing module within the gamma processor, stored in memory, or any combination thereof.

The process can further include receiving input data signals for the user electronic device, at block 504, and accessing the performance information for the user electronic device, at block 506. The input data signals and performance information can be received from memory, the CPU, a network, or another location. The input data signals and performance information may be sent from the same source or from different sources. The input data signals and performance information are received by the gamma processor in one embodiment.

The input data signals may be appropriate for a brand new display that is being operated for the first time. However, as the electronic device is used, charge carriers become trapped within the gate dielectrics of the power transistors, and the organic semiconductor materials degrade. Thus, if the input data signals are used, the desired output and luminance of the display may not be achieved. Thus, the input data signals need to be adjusted as the electronic device is used.

The process further includes generating the adjusted data signals using the historic data, the input data signals, and the performance information, at block 522. In one embodiment, the voltages of the input data signals can be integrated over time. Alternatively, other information, such as Vgs of the power transistors, current flowing through the radiation-emitting components, other suitable electrical parameter, or any combination thereof can be integrated over time. The processing module within the gamma processor can use the input data signals to determine the desired luminances of each subpixel and the historic data can be used to determine how long and hard each of the subpixels have been driven.

The processing module can access the performance information to determine how to adjust the input data signals to achieve desired luminances, given the then-current historic data. In a particular embodiment, the performance data can be in the form of a table, and the input data signals and historic data can be used to find corresponding entries within the performance information. The corresponding entries can be used to generate the adjusted data signals. Input data signals can be RGB, and the adjusted data signals can be R′B′G′. The process can be performed on a subpixel-by-subpixel basis.

The process can still further include generating processed signals from adjusted data signals, at block 602 in FIG. 6. A signal processor can receive the adjusted data signals and process them to provide processed signals that can be used by the display. The processing can include converting digital signals to analog signals, driving analog signals into the display, performing another suitable operation, or any combination thereof. The display will display an image closer to the desired image than if the adjusted data signals were not generated (i.e., the input data signals would be received by the signal processor).

The process can include determining whether the voltages between the Vdd lines and the Vss lines (“Vds”) are to be changed, at decision tree 622. If a voltage of any Vdd line or Vss is to be changed (“YES” branch from decision tree 622), the process can include changing voltage(s) of electrode(s) (e.g., Vdd or Vss lines) of the user electronic device, at block 624. The processing module within the gamma processor can make the determination and send appropriate instructions to the electrode control module, which in turn, can execute the instructions to change any single Vdd or Vss line or any combination of Vdd or Vss lines. In one embodiment, the processing module determines that the organic semiconductor material within the radiation-emitting component 368 degrades faster than the organic semiconductor materials within the radiation-emitting components 328 and 348. The processing module can send instructions to the electrode control module to change the voltage on Vdd line 360, Vss line 369, or both. The change may be independent of the other Vdd and Vss lines or may affect another Vdd or Vss line. In one particular embodiment, the Vss lines 329, 349, and 369 may be coupled to a common Vss line (not illustrated in FIG. 3). The common Vss line may be changed to achieve the proper voltage difference for radiation-emitting component 368. If the voltage differences for the radiation-emitting components 328 and 348 can be maintained by changing the Vdd lines 320 and 340 by the same amount as the common Vss line. After reading this specification, skilled artisans will appreciate that still other combinations of changing voltages of the electrodes can be used.

If a change to the electrode Vds is not made (“NO” branch of decision tree 622) or after the change has been made (block 624), a determination is made whether there are more input data signals, at decision tree 642. If there are more data input signals (“YES” branch from decision tree 642), the data from the currently used data input signals (i.e., the ones used for generating the display) become part of the historic data, and the process continues at block 502 in FIG. 5.

If there are not more data input signals (“NO” branch from decision tree 642), the process can include compensating the user electronic device, at block 662. A conventional or proprietary compensation scheme can be used. In general, the compensation scheme reverses the polarity of Vgs to remove trapped charge carriers from the gate dielectrics of the power transistors 326, 346, and 366. In one particular embodiment, the voltages of the Vdd and Vss lines are reversed. For example, if a Vdd line was +12 V and a Vss line was 0 V when displaying the image, the Vdd line can be changed to 0 V, and the Vss line can be change to +12 V. In another embodiment, the Vdd line is changed to −12V, and the Vss line remains unchanged at 0 V. In yet another embodiment, the Vdd line may be allowed to float, and the Vss line is taken to +12 V. Note that other voltages can be used, and the difference between Vdd and Vss lines do not need to be 12 V. The compensation can be performed when the electronic device is idling, in standby, or as part of a powering down sequence when the electronic device is being turned off.

The compensation time and conditions are also part of the historic data, and the process can also include generating historic data, at block 682. The manner for generating the history data can use a scheme as previously described with respect to block 502 in FIG. 5 (e.g., integrating voltage over time). The historic data generated in block 682 of FIG. 6 can be kept as a single set or as separate sets. If separate sets are kept, one set of historic data may not include the information collected during compensation. This set of historic data can better reflect how long and how intensely illuminated the display has been operated. Such information may be useful in determining the degradation of the organic semiconductor materials within the radiation-emitting components. Another set of data can include historic data from the previously described set and additional historic data from the compensation. In one embodiment, voltage is integrated over time. Because the polarity of the voltage during compensation is the opposite of the polarity of the voltage when images are being displayed, the integration results in a value closer to zero after compensation. Thus, this set of historic data (including compensation and image data) can better reflect the amount of trapped charge within the gate dielectrics of the power transistors. Such information can be useful when generating adjusted data signals from the input data signals.

### 4. Benefits

The methods and systems described herein can be used to fabricate electronic devices that allow, from an end-user perspective, more stable display performance over the lifetime of the electronic device. The methods and systems can use performance information generated from a different electronic device of the same model, or even the same batch, that can be used in the user electronic devices. When the performance information is generated from an electronic device fabricated in the same batch, all electronic devices in the batch can be substantially identical to one another. Thus, they can have the same organic semiconductor materials with substantially the same thicknesses, the electrodes can be of the same materials and substantially the same thicknesses and widths. Therefore, a tested electronic device from the same batch as the end users' electronic devices can provide performance information that is highly representative of the end users' electronic devices.

The method and systems can use the performance data together with historic data to generate adjusted data signals from input data signals to provide an image to be displayed that more closely reflects the desired image to be displayed, as compared to using the input data signals without an adjustment. Further, voltages of the electrodes can be changed. Thus, electronic devices may have a longer operating life.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A first electronic device comprising:
a first radiation-emitting component; and
a first processor operable to:
receive a first input data signal for the first radiation-emitting component;
receive performance information generated from a second electronic device, wherein the first electronic device and the second electronic device were fabricated in a same batch; and
generate a first adjusted data signal using the first input data signal and the performance information.

2. The first electronic device of claim 1, wherein generate the first adjusted data signal comprises generate the first adjusted data signal using first historic data, the first input data signal, and the performance information.

3. The first electronic device of claim 2, wherein the first historic data comprises (i) time information and (ii) voltages of other first input data signals, voltages of the other first adjusted data signals, currents flowing through the first radiation-emitting component, or any combination thereof.

4. The first electronic device of claim 1, further comprising an electrode control module operable to change a voltage of a first cathode of the first electronic device, a first anode of the first electronic device, or a combination thereof.

5. The first electronic device of claim 1, wherein:
the first radiation-emitting component comprises a first organic semiconductor material having a first emission maximum at a first wavelength; and
the first electronic device further comprises:
a second radiation-emitting component comprising a second organic semiconductor material having a second emission maximum at a second wavelength different from the first wavelength; and
a third radiation-emitting component comprising a third organic semiconductor material having a third emission maximum at a third wavelength, wherein the third wavelength is different from each of the first and second wavelengths.

6. The first electronic device of claim 5, wherein the first processor is further operable to:
receive a second input data signal for the second radiation-emitting component;
generate a second adjusted data signal using the second input data signal and the performance information;
receive a third input data signal for the third radiation-emitting component; and
generate a third adjusted data signal using the third input data signal and the performance information.

7. The first electronic device of claim 6, further comprising a second processor operable to:
receive the first adjusted data signal, the second adjusted data signal, and the third adjusted data signal; and
generate a first processed signal, a second processed signal, and third processed signal from the first adjusted data signal, the second adjusted data signal, and the third adjusted data signal, respectively.

8. A process of making and using electronic devices comprising:
fabricating a first batch of electronic devices, wherein the first batch includes a first electronic device and a second electronic device;
generating first performance information using the second electronic device;
providing the first performance information to the first electronic device;
fabricating a second batch of electronic devices, wherein the second batch includes a third electronic device and a fourth electronic device;
generating second performance information using the fourth electronic device, wherein the second performance information is different from the first performance information; and
providing the second performance information to the third electronic device,
wherein the first, second, third, and fourth electronic devices are a same model and include a first radiation-emitting component.

9. The process of claim 8, wherein providing the first performance information comprises storing the first performance information in a memory of the first electronic device.

10. The process of claim 9, wherein providing the first performance information comprises transmitting the first performance information over an Internet to the first electronic device.

11. The process of claim 8, further comprising:
updating the first performance information to generate updated performance information; and
transmitting the updated performance information over the Internet to the first electronic device.

12. The process of claim 8, further comprising:
fabricating additional batches of electronic devices, wherein each of the additional batches includes a user electronic device and a tested electronic device;
for each additional batch, generating additional performance information from the tested electronic device; and
for each additional batch, providing the additional performance information to the user electronic device within a same additional batch as a corresponding tested electronic device.

13. The process of claim 8, wherein:
the first radiation-emitting component comprises a first organic semiconductor material having a first emission maximum at a first wavelength; and
each of the first, second, third, and fourth electronic devices further comprises:
a second radiation-emitting component comprises a second organic semiconductor material having a second emission maximum at approximately a second wavelength that is significantly different from the first wavelength; and
a third radiation-emitting component comprises a third organic semiconductor material having a third emission maximum at approximately a third wavelength that is significantly different from each of the first and second wavelengths.

14. A process of using a first electronic device comprising:
at a first processor, receiving a first input data signal for a first radiation-emitting component of the first electronic device; and
generating a first adjusted data signal using the first input data signal and performance information, wherein the performance information was generated from a second electronic device that was fabricated in a same batch as the first electronic device.

15. The process of claim 14, wherein generating the first adjusted data signal comprises generating the first adjusted data signal using first historic data, the first input data signal, and the performance information.

16. The process of claim 15, wherein the first historic data comprises (i) time information and (ii) voltages of other first input data signals, voltages of the other first adjusted data signals, currents flowing through the first radiation-emitting component, or any combination thereof.

17. The process of claim 14, further comprising changing a voltage of a first cathode of the first electronic device, a first anode of the first electronic device, or a combination thereof.

18. The process of claim 14, further comprising:
receiving the performance information over an Internet; and
storing the performance information in a memory of the first electronic device.

19. The process of claim 14, wherein:
the first radiation-emitting component comprises a first organic semiconductor material having a first emission maximum at a first wavelength; and
the first electronic device further comprises:
a second radiation-emitting component comprises a second organic semiconductor material having a second emission maximum at a second wavelength different from the first wavelength; and
a third radiation-emitting component comprises a third organic semiconductor material having a third emission maximum at a third wavelength, wherein the third wavelength is different from each of the first and second wavelengths.

20. The process of claim 19, further comprising:
at the first processor:
receiving a second input data signal for the second radiation-emitting component; and
receiving a third input data signal for the third radiation-emitting component;
generating a second adjusted data signal using the second input data signal and the performance information; and
generating a third adjusted data signal using the third input data signal and the performance information.
